(19) United States
(12) Patent Application Publication
(10) Pub. No.: US 2014/0078078 A1
(43) Pub. Date: Mar. 20, 2014

(54) GRAPHICAL USER INTERFACE (GUI) WIDGET FOR STABLE HOLDING AND CONTROL OF SMART PHONE BASED ON TOUCH SCREEN

(71) Applicant: Korea Advanced Institute of Science and Technology, (US)

(72) Inventors: Geehyuk Lee, Daejeon (KR); Jong Gi Hong, Gyeongsan-si (KR)

(73) Assignee: KOREA ADVANCED INSTITUTE OF SCIENCE AND TECHNOLOGY, Daejeon (KR)

(21) Appl. No.: 13/711,553

(22) Filed: Dec. 11, 2012

(30) Foreign Application Priority Data
Sep. 20, 2012 (KR) 10-2012-0104411

(51) Int. Cl. G06F 3/048

(52) U.S. Cl. CPC G06F 3/048
USPC 345/173

(57) ABSTRACT

A control method using a touch shield to be performed by a touch sensing display, and an electronic apparatus are provided. The control method using the touch shield may include determining a touch area of a touched point in a normal state, switching to a touch shield state when the touch area is greater than or equal to a threshold value, and executing an instruction in response to a movement of the touched point in the touch shield state.

### CROSS-REFERENCE TO RELATED APPLICATION

This application claims the benefit of Korean Patent Application No. 10-2012-0104411, filed on Sep. 20, 2012, in the Korean Intellectual Property Office, the entire disclosure of which is incorporated herein by reference for all purposes.

### BACKGROUND

1. Field of the Invention

The present invention relates to a graphical user interface (GUI) design applicable to a touch screen-based smart phone, and more particularly, to a GUI widget configured to increase stability when using the touch screen-based smart phone with a single hand.

2. Description of the Related Art

A touch screen is a typical input device of a smart phone. Most touch screens for smart phones are based on a touch sensing method using capacitive sensing, and may have a function of sensing a plurality of touched points simultaneously. In capacitive sensing, a contact of a grounded object, for example, a finger, may be sensed, without need for a force applied in association with the contact, unlike resistive sensing. Such a characteristic may be a great advantage of capacitive sensing, and may enable a smooth and light control of a touch screen. However, the advantage may cause a usability problem, too, since an unintended command may be executed when a light contact is made by mistake. In particular, since a number of graphical user interface (GUI) controls that may be executed with a light touch may be scattered on the touch screen, holding the screen while reading contents on the screen is impossible. By the way, holding the smart phone without touching the screen may be difficult in a case in which the smart phone is to be controlled with a thumb while holding the smart phone with a single hand in a mobile environment. Further, holding the smart phone may be more difficult in a case in which the thumb is to be moved to touch multiple points of the screen.

In order to alleviate such an inconvenience, a touch screen that can distinguish a light touch and a press action by sensing a finger pressure is being introduced. This solution however may be in conflict with the advantage of a capacitive sensing touch screen, i.e., light touch operations.

A light contact being made by a fingertip may be distinguished from a contact being made with a wide surface covered by a finger. In fact, a capacitive touch screen may obtain a signal proportional to a contact area, and may estimate a degree of the contact using the obtained signal. Research is being conducted on a method of designing a touch screen capable of identifying types of touches using such a degree of a contact and executing instructions depending on the types of the touches.

In addition to the disadvantage of an unstable grip, a smart phone with a large touch screen may have another disadvantage in controlling shortcut keys, and the like. Shortcut keys may be provided as a touch sensor or a physical button below the screen. In this instance, controlling the shortcut keys with a thumb while holding the smart phone with a single hand may be unstable.

Accordingly, there is a need for a technology for increasing grip stability and control stabilities, simultaneously.

### SUMMARY

An aspect of the present invention provides a technology for guaranteeing a stable control by generating a touch shield widget when a touch area greater than or equal to a threshold value is maintained for a threshold time.

According to an aspect of the present invention, there is provided a control method using a touch shield, the method performed by a touch sensing display, the method including determining a touch area of a touched point in a normal state, switching to a touch shield state when the touch area is greater than or equal to a threshold value, and executing an instruction in response to a movement of the touched point in the touch shield state.

The switching may include switching to an intermediate state when the touch area is greater than or equal to the threshold value, and switching to the touch shield state when the touched point is maintained for a threshold time in the intermediate state.

The switching to the touch shield state when the touched point is maintained for the threshold time in the intermediate state may include switching to the touch shield state when the touch area is maintained to be greater than or equal to the threshold value for the threshold time in the intermediate state.

The switching to the touch shield state when the touched point is maintained for the threshold time in the intermediate state may include generating a touch shield widget.

The generating may include providing an animation to generate the touch shield widget.

The providing may include providing the animation around the touched point.

The method may further include switching to the normal state when the touched point is released in the intermediate state.

The method may further include switching to the normal state when the touched point is moved in the intermediate state.

The method may further include switching to the normal state when the touched point is out of a touch shield area in the intermediate state.

The method may further include switching to the normal state when the touched point is released in the touch shield state.

The executing may include executing an instruction corresponding to upper, lower, left, and right directions respectively, when the touched point is moved in one of the upper, lower, left, and right directions, on the touch shield widget.

The touch shield widget may include a marking menu, and the executing may include executing an instruction corresponding to a predetermined menu selection when the touched point is moved to the predetermined menu selection of the marking menu.

The executing may include executing an instruction corresponding to a pattern when the touched point is moved along the pattern on the touch shield widget.

According to another aspect of the present invention, there is provided an electronic apparatus controlled using a touch shield, the apparatus including a touch sensing display, a processing apparatus, and a computer storage medium including instructions for controlling the processing apparatus to perform operations during execution performed by the processing apparatus, wherein the operations may include determining a touch area of a touched point in a normal state, switching to a touch shield state when the touch area is greater than or equal to a threshold value, and executing an instruction in response to a movement of the touched point in the touch shield state.

The switching may include switching to an intermediate state when the touch area is greater than or equal to the threshold value, switching to the touch shield state when the touch area is maintained to be greater than or equal to the threshold value for a threshold time in the intermediate state, and generating a touch shield widget in the touch shield state.

The operations may further include switching to the normal state when the touched point is released, moved, or out of a touch shield area, in the intermediate state.

The operations may further include switching to the normal state when the touched point is released in the touch shield state.

The executing may include executing an instruction corresponding to upper, lower, left, and right directions respectively, when the touched point is moved in one of the upper, lower, left, and right directions, on the touch shield widget.

The touch shield widget may include a marking menu, and the executing may include executing an instruction corresponding to a predetermined menu selection when the touched point is moved to the predetermined menu selection of the marking menu.

The executing may include executing an instruction corresponding to a pattern when the touched point is moved along the pattern on the touch shield widget.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a flowchart illustrating a control method using a touch shield according to an embodiment of the present invention;

FIG. 2 is a diagram illustrating a touch shield implemented in a multi-window system environment according to an embodiment of the present invention;

FIG. 3 is a diagram illustrating a detailed design of a touch shield widget according to an embodiment of the present invention;

FIG. 4 is a state transition diagram of a touch shield according to an embodiment of the present invention; and

FIG. 5 is a block diagram illustrating a detailed configuration of an electronic apparatus controlled using a touch shield according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

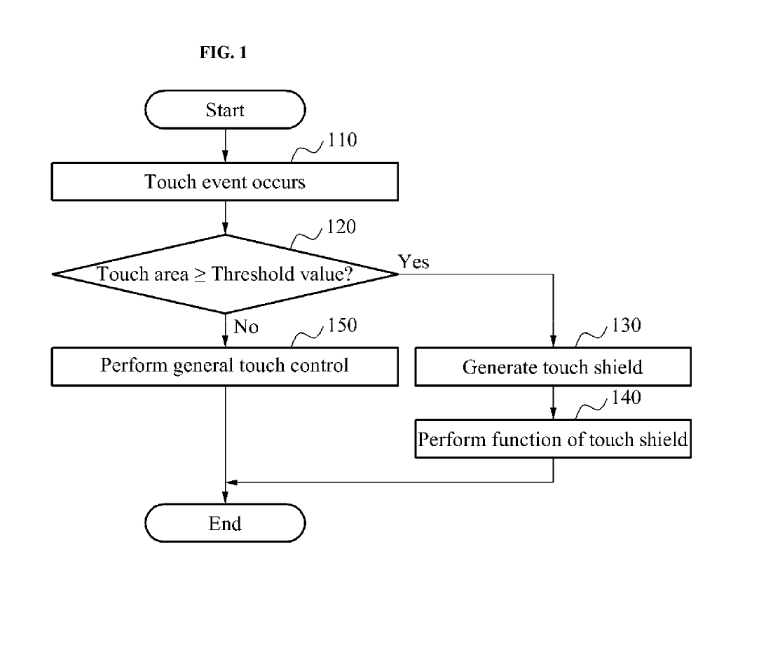

FIG. 1 is a flowchart illustrating a control method using a touch shield according to an embodiment of the present invention.

In operation 110, when a touch screen event occurs, a touch area of a touched point at which the touch screen event occurs may be determined.

In operation 120, whether the touch area is greater than or equal to a threshold value may be determined. In particular, in a case in which a touch screen event occurs when a touch screen is touched by a finger, the touch screen event may be processed differently depending on the contact area between the finger and the touch screen. Here, the threshold value may be determined by manual settings of a user, learning use tendencies of an individual user, or an average according to statistics with respect to use by multiple users.

For example, the threshold value of the touch area may be determined experimentally. A distribution of the touch area may be extracted by measuring touch areas in two cases, one case of touching the touch screen with a fingertip and the other case of touching the touch screen with an inside surface of a finger, with respect to multiple users. An initial value of the threshold value may be determined to be a value classifying the two cases distinctly. When samples of the touch area are accumulated as an individual user uses the touch screen, the samples of the touch area may be classified into two groups based on the initial threshold, and a personalized threshold value may be determined by detecting a boundary value classifying the two groups distinctly.

In operation 130, when the touch area is greater than or equal to the threshold value, a touch shield may be generated. In particular, when the contact area, for example, the touch area, is greater than or equal to the threshold value, an uppermost widget named a touch shield may be generated at the touched point. The touch screen event may be processed by the touch shield, and may not be transferred to an application.

In operation 140, a function of the generated touch shield may be performed. For example, the generated touch shield may be maintained until the finger leaves the screen. Accordingly, when a user touches the touch screen with a wide surface of the finger, the user may hold the screen without touching an application.

In operation 150, when the touch area is less than the threshold value, a general touch control may be performed. For example, when the contact area is less than a predetermined level, for example, the threshold value, the touch screen event may be regarded as a general touch screen event. A touch message may be transferred to an application, and may be connected to controls, for example, selection, drag, and the like.

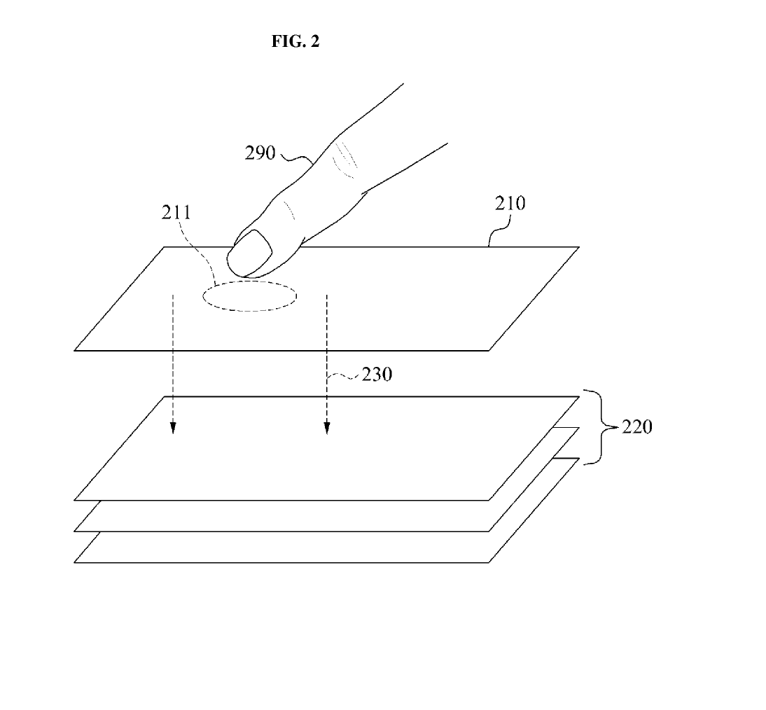

FIG. 2 is a diagram illustrating a touch shield 211 implemented in a multi-window system environment according to an embodiment of the present invention.

Referring to FIG. 2, a touch shield service may maintain a transparent touch shield window 210 on all application windows 220. The touch shield window 210 may be disposed at an uppermost area. The touch shield window 210 may receive, as a touch message 230, all touch screen events transferred from a system, for example, a touch event, a move event, a release event, and the like. The touch shield window 210 may verify whether a touch area is greater than or equal to, or less than a threshold value when a touch event occurs, as shown in FIG. 1. When the touch area is less than the threshold value, the touch shield window 210 may transfer the touch screen events to an application window disposed below. When the touch area is greater than or equal to the threshold value, the touch shield window 210 may generate a touch shield widget.

In particular, the touch shield widget may be displayed in a predetermined area under a finger 290, with the transparent touch shield window 210 in a background. Once the touch shield is generated, the touch shield may be maintained until the finger 290 leaves the screen, for example, until a touched point is released or out of a touch shield area. While the touch shield is maintained, a shortcut key provided by the touch shield may be used by dragging the finger 290 upper, lower, left, and right directions, as like controlling a joystick.

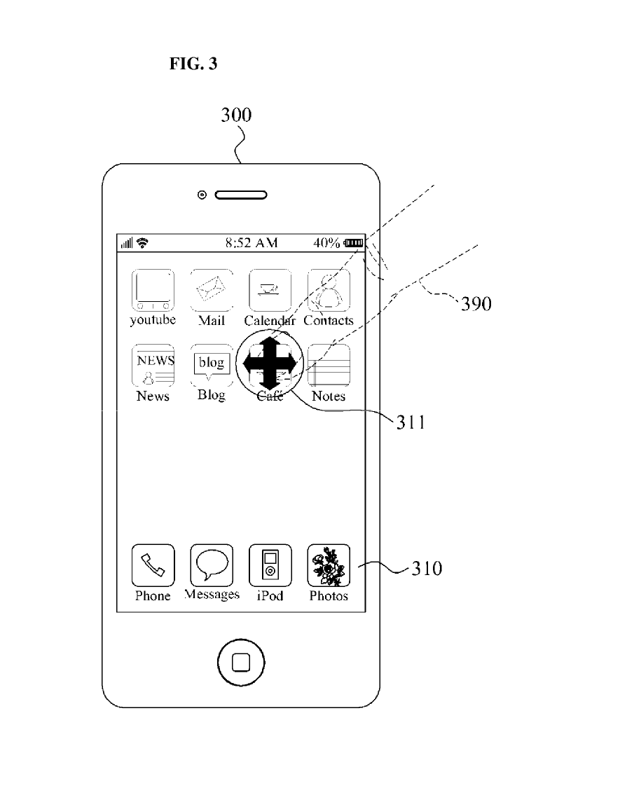

FIG. 3 is a diagram illustrating a detailed design of a touch shield widget 311 according to an embodiment of the present invention. Here, the touch shield widget 311 may be included in a touch shield. In order to feed back, to a user, that a touch shield mode is activated, the touch shield may need to be visible. However, because contents on a screen 310 of an electronic apparatus 300 may need to be viewed while the screen 310 is being held, the touch shield may be configured to not occupy a large area, and to occupy an area displayed to be translucent so as not to obscure contents under the touch shield.

In addition, as shown in FIG. 3, the touch shield widget 311 may provide up, down, left, and right arrows in order to support a simple shortcut input while the screen 310 is held. When the finger 390 moves in an arrow direction, a designated instruction may be executed. Instructions corresponding to respective directions may depend on a current application, or may correspond to common instructions applied to the entire system. For example, the left arrow may correspond to “Back,” the right arrow may correspond to “Menu,” the up arrow may correspond to “Home,” and the down arrow may correspond to “Screen Lock.”

Here, the four movements in the upper, lower, left, and the right directions have been provided as an example. Instead, a gesture input scheme capable of dealing with more varied instructions, for example, a marking menu, may be applied. In particular, when the touched point is moved to a predetermined menu of the marking menu, a corresponding instruction may be executed. Also, when the touched point is moved along a predetermined pattern within the touch shield area on the touch shield widget, an instruction corresponding to the pattern may be executed.

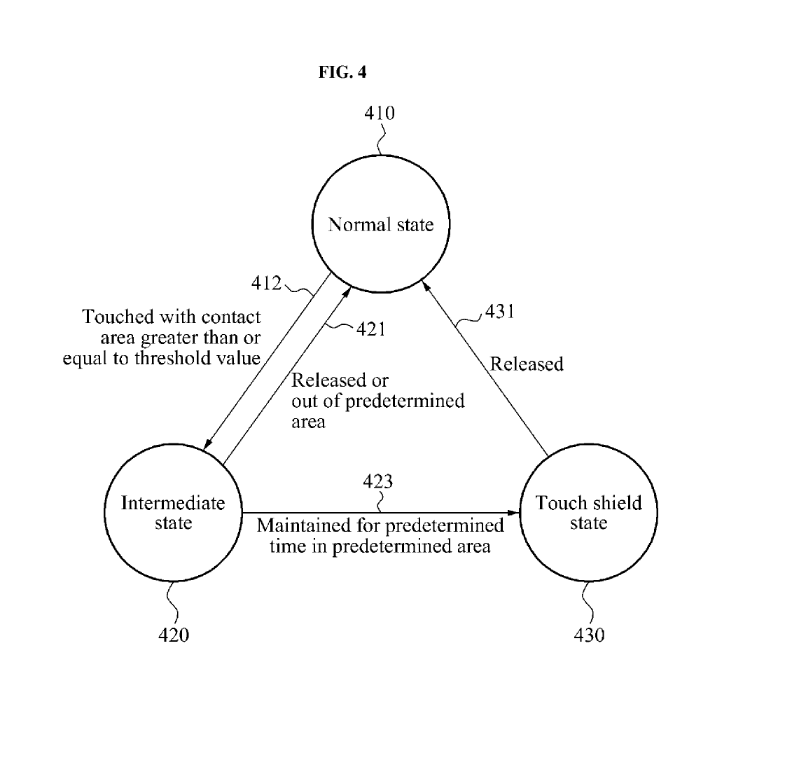

FIG. 4 is a state transition diagram of a touch shield according to an embodiment of the present invention. In a detailed implementation of a concept of the touch shield, avoiding a collision with an existing touch screen control may be important. For example, although a screen is touched to select an icon on the screen, a touch shield widget may be generated. Although the screen is touched to scroll the screen, the touch shield widget may be generated such that the scroll may be obstructed. Prevention of such cases may necessary.

In order to manage such cases, before the touch shield widget is generated, an intermediate state 420 may be provided to cancel generation of the touch shield widget. For example, the touch shield widget may provide an animation that may be generated gradually, in the intermediate state 420. When the animation is not desired, a general touch screen control may be continued by taking a finger off to release a contact point or by adjusting a contact area to be less than a threshold value. In addition, when the contact point is moved in the intermediate state 420, it may be determined that a drag control is desired instead of the touch shield widget, and switching to a touch shield state 430 may be cancelled.

The touch shield service may include three states, and an operation corresponding to a touch screen event may be determined depending on the states. A normal state 410 may refer to a state in which the touch shield widget is yet to be activated. The normal state 410 may correspond to a state in which all touch screen events are not blocked so that a normal touch control, for example, clicking or dragging an icon, and the like, may be performed by users.

When a user performs a touch with a contact area greater than or equal to a threshold value in the normal state 410, the touch shield service may switch to the intermediate state 420, in operation 412. In the intermediate state 420, all touch screen events may be still transferred to an application. In order to show that the touch shield service is in a preparatory stage for switching to the touch shield state 430 in which the touch screen events are blocked, an animation of the touch shield widget being generated may be displayed around the contact point. However, in the intermediate state 420, when the touched point is released by removing the finger from the touch screen, when the touched point is moved, or when the touched point is out of the touch shield area, the touch shield service may switch to the normal state 410, in operation 421.

When the user maintains the touched point for a threshold time within the touch shield area, in the intermediate state 420, it may be regarded that the touch shield widget is desired, and the touch shield service may switch to the touch shield state 430, in operation 423. When the touch shield service switches to the touch shield state 430, all touch screen events may not be transferred to the application, and a shortcut instruction may be executed using a drag control, as described above. When the touched point is released by removing the finger from the touch screen, in the touch shield state 430, the touch shield service may switch to the normal state 410, in operation 431. Here, the threshold time may be determined by manual settings of a user, learning use tendencies of an individual user, or an average according to statistics with respect to use by multiple users.

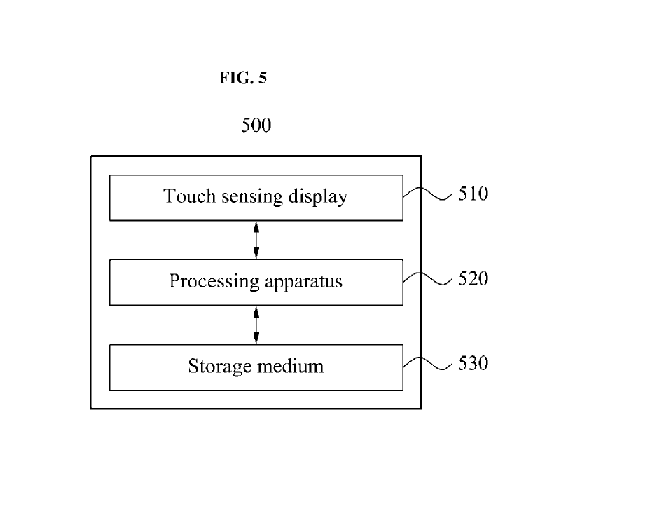

FIG. 5 is a block diagram illustrating a detailed configuration of an electronic apparatus 500 controlled using a touch shield according to an embodiment of the present invention.

Referring to FIG. 5, the electronic apparatus 500 may include a touch sensing display 510, a processing apparatus 520, and a storage medium 530.

The touch sensing display 510 may sense a touch area when a screen is touched by a finger of a user, or other objects. The touch sensing display 510 may include a pressure-sensitive touch sensing display that senses a touch through a pressure by a physical force, and a capacitive touch sensing display that senses a change in current of the touch screen. According to the present embodiment, the capacitive touch sensing display that may determine the touch area more readily may be used.

The processing apparatus 520 may refer to an apparatus for processing operations based on programs stored in the storage medium 530, and may include a central processing unit (CPU), and other microprocessors. According to the present embodiment, the processing apparatus 520 may determine whether a touch shield widget is to be generated, by determining whether the touch area sensed by the touch sensing display 510 is greater than or equal to a threshold value, whether a touched point is maintained for longer than a threshold time, and the like.

The storage medium 530 may refer to a computer storage medium including instructions for controlling the processing apparatus 520 to perform operations during execution performed by the processing apparatus 520. Here, the operations may include determining a touch area of a touched point in a normal state, switching to a touch shield state when the touch area is greater than or equal to a threshold value, and executing an instruction in response to a movement of the touched point in the touch shield state. In this instance, the storage medium 530 may correspond to, for example, hardware in which a hard disk, a solid state drive (SSD), and other programs may be stored.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The application or software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The method according to the above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

According to exemplary embodiments of the present invention, it is possible to prevent malfunction by generating a graphical user interface (GUI) widget, named a touch shield, under a thumb when a screen is touched by a wide surface under the thumb to block a manipulation of another GUI control since a number of GUI controls that may be executed at a modest touch are scattered on a touch screen and holding the screen with the thumb may be difficult although more stable holding of a smart phone may be possible when the screen is held with the thumb in a case of controlling the smart phone with a single hand.

According to exemplary embodiments of the present invention, it is possible to hold a screen while avoiding an interference with a GUI control on a touch screen when the screen is touched by an inside part of the thumb, as oppose to a fingertip, since whether the screen is touched by the inside part of the thumb or by the fingertip may be readily distinguished based on information on a touch area provided by a capacitive touch screen.

According to exemplary embodiments of the present invention, it is possible to use a frequently used shortcut key while maintaining stable holding through a touch shield.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A control method using a touch shield, the method performed by a touch sensing display, the method comprising:
determining a touch area of a touched point in a normal state;
switching to a touch shield state when the touch area is greater than or equal to a threshold value; and
executing an instruction in response to a movement of the touched point in the touch shield state.

2. The method of claim 1, wherein the switching comprises:
switching to an intermediate state when the touch area is greater than or equal to the threshold value; and
switching to the touch shield state when the touched point is maintained for a threshold time in the intermediate state.

3. The method of claim 2, wherein the switching to the touch shield state when the touched point is maintained for the threshold time in the intermediate state comprises switching to the touch shield state when the touch area is maintained to be greater than or equal to the threshold value for the threshold time in the intermediate state.

4. The method of claim 2, wherein the switching to the touch shield state when the touched point is maintained for the threshold time in the intermediate state comprises generating a touch shield widget.

5. The method of claim 4, wherein the generating comprises providing an animation to generate the touch shield widget.

6. The method of claim 5, wherein the providing comprises providing the animation around the touched point.

7. The method of claim 2, further comprising:
switching to the normal state when the touched point is released in the intermediate state.

8. The method of claim 2, further comprising:
switching to the normal state when the touched point is moved in the intermediate state.

9. The method of claim 2, further comprising:
switching to the normal state when the touched point is out of a touch shield area in the intermediate state.

10. The method of claim 1, further comprising:
switching to the normal state when the touched point is released in the touch shield state.

11. The method of claim 4, wherein the executing comprises executing an instruction corresponding to upper, lower, left, and right directions respectively, when the touched point is moved in one of the upper, lower, left, and right directions, on the touch shield widget.

12. The method of claim 4, wherein:
the touch shield widget comprises a marking menu, and
the executing comprises executing an instruction corresponding to a predetermined menu selection when the touched point is moved to the predetermined menu selection of the marking menu.

13. The method of claim 4, wherein the executing comprises executing an instruction corresponding to a pattern when the touched point is moved along the pattern on the touch shield widget.

14. An electronic apparatus controlled using a touch shield, the apparatus comprising:
a touch sensing display;
a processing apparatus; and
a computer storage medium comprising instructions for controlling the processing apparatus to perform operations during execution performed by the processing apparatus,
wherein the operations comprise:
determining a touch area of a touched point in a normal state;
switching to a touch shield state when the touch area is greater than or equal to a threshold value; and
executing an instruction in response to a movement of the touched point in the touch shield state.

15. The apparatus of claim 14, wherein the switching comprises:
switching to an intermediate state when the touch area is greater than or equal to the threshold value;
switching to the touch shield state when the touch area is maintained to be greater than or equal to the threshold value for a threshold time in the intermediate state; and
generating a touch shield widget in the touch shield state.

16. The apparatus of claim 15, wherein the operations further comprise:
switching to the normal state when the touched point is released, moved, or out of a touch shield area, in the intermediate state.

17. The apparatus of claim 14, wherein the operations further comprise:
switching to the normal state when the touched point is released in the touch shield state.

18. The apparatus of claim 15, wherein the executing comprises executing an instruction corresponding to upper, lower, left, and right directions respectively, when the touched point is moved in one of the upper, lower, left, and right directions, on the touch shield widget.

19. The apparatus of claim 15, wherein:
the touch shield widget comprises a marking menu, and
the executing comprises executing an instruction corresponding to a predetermined menu selection when the touched point is moved to the predetermined menu selection of the marking menu.

20. The apparatus of claim 15, wherein the executing comprises executing an instruction corresponding to a pattern when the touched point is moved along the pattern on the touch shield widget.
